(19) United States
(12) Patent Application Publication
(10) Pub. No.: US 2013/0014347 A1
(43) Pub. Date: Jan. 17, 2013

(54) HINGE

(71) Applicant: Antoni Rodo Sane, Sabadell, (Barcelona) (ES)

(72) Inventor: Antoni Rodo Sane, Sabadell, (Barcelona) (ES)

(73) Assignee: ILLINOIS TOOL WORKS, INC., Glenview, IL (US)

(21) Appl. No.: 13/636,419

(22) PCT Filed: Apr. 22, 2011
(86) PCT No.: PCT/US2011/033530

§ 371 Date: Sep. 21, 2012

(30) Foreign Application Priority Data
May 6, 2010 (ES) P 201000579

(51) Int. Cl. E05D 1/02; E05D 5/02

(52) U.S. Cl. 16/387

(57) ABSTRACT

Hinge, in particular of the type used in household appliances and in particular in washing machines, which is formed by a body, the surface of which has, arranged vertically thereon, a base in the form of a profile with a U-shaped cross-section and, extending from said base, lugs which are also formed with a profile having a U-shaped cross-section, said lugs being bent so as to form the elements for securing to the door, which are also formed with a profile having a U-shaped cross-section.

### FIELD OF THE INVENTION

The present invention concerns a hinge, in particular such as those used on the doors of washing machines, of the type having a structure for securing to the fixed body and equipped with pivots on which the door rotates, in which hinge the strength of the material and its robustness have been reinforced structurally and at the same time its composition lightened.

### PRIOR ART

Hinges used on doors of household appliances, especially washing machines, are known, which hinges are formed, in the prior art, by a solid body with holes for effecting fastening or points for performing securing to the body of the household appliance, for example, by means of screws. Securing to the washing machine is performed by means of pivots, consisting of solid shafts, on which the door of said household appliance rests and rotates.

In view of its limited elastic behavior, this structure has a number of drawbacks such that the opening and closing movements of the door performed by the users, on occasions, owing to forcing of the articulated parts of the mechanism, cause breakage of said pivots and the hinge itself.

Consequently, one of the main objects of the present invention is to provide a hinge which improves the prior art for said type of applications.

Another of the objects of the present invention is also to provide a lighter hinge made of material which results in a reduction in the cost of manufacture thereof.

Finally, another of the main objects of the present invention is to provide a hinge which is stronger than the present hinges and which is able to withstand satisfactorily the additional forces which on occasions users may exert on said part.

These and other objects of the present invention will become clearer during the course of the description thereof provided below.

### BRIEF DESCRIPTION OF THE INVENTION

The hinge of the present invention is formed by a base which has, extending vertically from its surface, a profile with a U-shaped cross-section to which profiled lugs also with a U-shaped cross-section are attached, the bent ends of said lugs, in the form of a profile with a U-shaped cross-section, forming the securing elements for the door.

The surface of the hinge has at least one embossed reinforcing zone and means for performing securing to the washing machine.

### BRIEF DESCRIPTION OF THE DRAWINGS

In order to facilitate understanding of the invention, the latter is accompanied by a sheet of drawings provided solely by way of a non-limiting example of the invention.

FIG. 1 shows a perspective view of a preferred embodiment of a hinge according to the present invention.

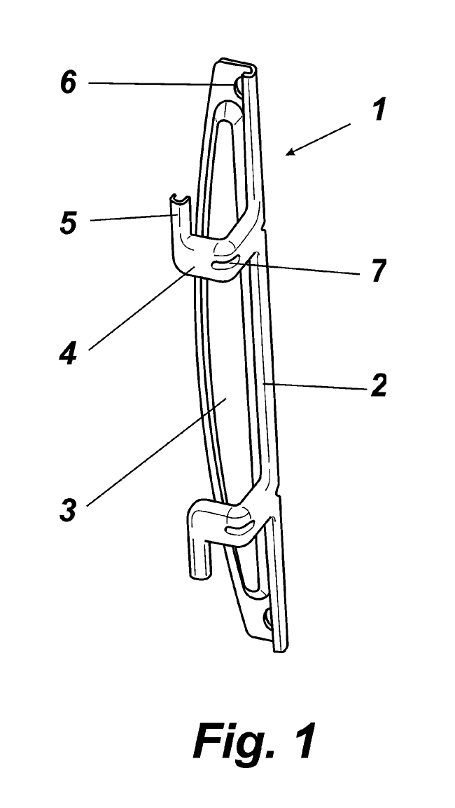

### DETAILED DESCRIPTION OF THE INVENTION

The present invention consists of a hinge (1), in particular of the type used in household appliances such as washing machines, formed by a body, the surface of which has, arranged vertically thereon, a profile (2) with a U-shaped cross-section and, extending therefrom, lugs (4) which are also formed with a profile having a U-shaped cross-section, said lugs (4) being bent so as to form the elements for securing to the door (5), which are also formed with a profile having a U-shaped cross-section.

In the preferred embodiment of the invention, the body of the hinge (1) is provided with an embossed reinforcing zone (3), and the means for performing securing to the washing machine consist of holes (6) for receiving fixing screws.

The lugs (4) may incorporate on their surface structural reinforcing deformations (7).

The structure according to the invention not only results in a reduction in the material used to manufacture the hinge, but also results in a part which is very strong. The hinge is able to withstand in an optimum manner the associated working stresses, providing a hinge which is strong and has a long working life.

Any material convenient for its intended use, such as steel, may be used for the hinge.

It is understood that in the present case details regarding the finish or form may be variable provided that they do not modify the basic idea of the invention.

1. HINGE, of the type used in household appliances and in particular in washing machines, wherein the elements for securing to the door are formed by means of profiles with an approximately U-shaped cross-section.

2. HINGE, as claimed in claim 1, wherein said securing elements are the continuation of lugs formed by means of profiles with an approximately U-shaped cross-section.

3. HINGE, as claimed in claim 1, wherein said lugs extend from a profile with an approximately U-shaped cross-section.

4. HINGE, as claimed in claim 1, wherein said profile is arranged vertically on its surface.

5. HINGE, as claimed in claim 1, wherein said body of the hinge has an embossed reinforcing zone on its surface.

6. HINGE, as claimed in clam 1, wherein said lugs have structural reinforcing deformations.

7. HINGE, as claimed in claim 1, wherein its means for performing securing to the washing machine consist of holes for receiving fixing screws.
